(19) United States
(12) Patent Application Publication
(10) Pub. No.: US 2024/0315200 A1
(43) Pub. Date: Sep. 26, 2024

(54) PAW CLEANER

(71) Applicant: Joseph Damian Ek, Stillwater, MN (US)

(72) Inventor: Joseph Damian Ek, Stillwater, MN (US)

(21) Appl. No.: 18/613,937

(22) Filed: Mar. 22, 2024

Related U.S. Application Data
(60) Provisional application No. 63/454,052, filed on Mar. 23, 2023.

(51) Int. Cl. A01K 13/00

(52) U.S. Cl. CPC A01K 13/001

(57) ABSTRACT

According to the present invention disclosed herein, there is provided an animal paw washing device, comprising: an inner casing configured to hold water when water is added to the device; soap or other cleaning composition provided in solid form; a tray for the soap or other cleaning composition provided in solid form, wherein a portion of the soap or other cleaning composition provided in solid form is dissolvable to form a solution in inner casing when water is added.

### BACKGROUND

Apparatuses for cleaning an animal's paw have been disclosed in the prior art patent literature.

For example, U.S. Pat. No. 6,851,391 discloses an apparatus for cleaning an animal's paw that broadly comprises an elongated rigid cylindrical sidewall having an end wall and an open rim which substantially seals to an animal's paw as the paw is withdrawn from the apparatus. The rim is preferably fluted such that the paw is guided into the apparatus without snagging or catching. A cleaning element may be located within the apparatus to assist in cleaning the paw. The cleaning element may be a sponge, a brush, a plurality of projections, or other related object. In use, the apparatus is partially filled with a liquid and the paw is inserted through the rim and into the apparatus. A user then agitates the paw within the apparatus such that the paw is cleaned by contacting the cleaning element. The user then withdraws the paw from the apparatus, thereby creating a suction effect which draws additional dirt and debris away from the paw.

U.S. Pat. No. 11,503,804 discloses an automatic animal paw washing machine including a container having a flexible cover and opening at an open end thereof and a plurality of brushes secured therewithin. The brushes are in mechanical communication with a mechanism capable of being activated by a switch. The plurality of brushes is motioned in a rotating fashion when activated. The flexible cover is capable of being removed from the washing machine.

However, paw cleaners typically require adding liquid soap to the water to enhance the cleaning process, which is inconvenient and messy.

### SUMMARY OF INVENTION

Therefore, the present invention provides a device which allows for the use of soap or other similar cleansing compounds in solid form in a paw cleaner.

Water can be added to the device of embodiments of the present invention allowing for a portion of the solid soaps or other cleansing compounds to dissolve into solution which can then be used to clean the paw of an animal.

According to an aspect of the present invention disclosed herein, there is provided an animal paw washing device, comprising: an inner casing configured to hold water when water is added to the device; soap or other cleaning composition provided in solid form; a tray for the soap or other cleaning composition provided in solid form, wherein a portion of the soap or other cleaning composition provided in solid form is dissolvable to form a solution in inner casing when water is added.

### BRIEF DESCRIPTION OF THE DRAWINGS

FIG. 1 is an illustration of a device according to an embodiment of the present invention.

FIG. 2 is an illustration of an exploded view of the device.

FIG. 3 is an illustration of a cross-sectional view of the device.

### DETAILED DESCRIPTION

Animal paw cleaning devices are generally constructed of a container for holding water and within this container are commonly found bristles of one form or another. Users of dog paw cleaners sometimes add liquid soap to the water to enhance the cleaning process.

The disadvantage of using liquid soap is that it requires a second container for the soap and the soap must be added to the water every time the paw cleaner water is emptied and then refilled. An additional disadvantage of liquid soap is that it can be messy.

The present invention is for a receptacle or holder to be placed into the paw cleaner or integrated into the paw cleaner at time of manufacture. The receptacle is for holding a dissolvable quantity of soap or other useful chemical in solid form.

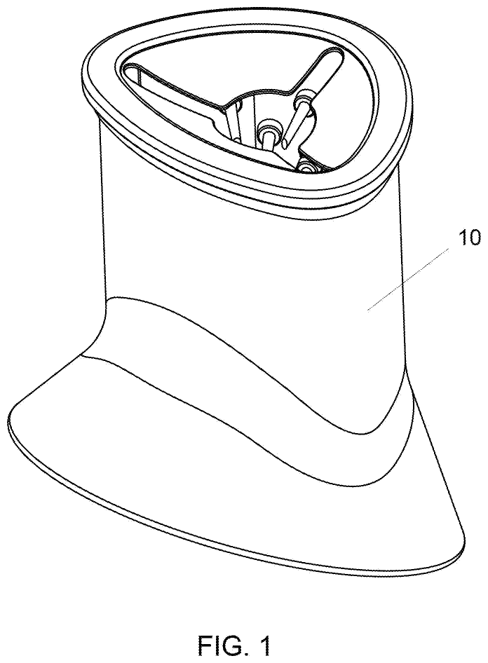

FIG. 1 is an illustration of a device, paw cleaner 10, according to an embodiment of the present invention.

When water is placed into the paw cleaner, some percentage of the solid dissolves, putting soap into solution in the water. After use, the water is discarded but the remainder of the solid soap stays within the receptacle.

At next use, the user needs only to add more water and the soap is automatically dispersed into the water as the solid soap dissolves. When the soap is completely dissolved a new bar can be placed on the tray in the container.

The dissolvable solid could also contain other beneficial ingredients besides soap such as anti-allergens or substances which bind and help remove potential irritants, such as road salt used in the winter.

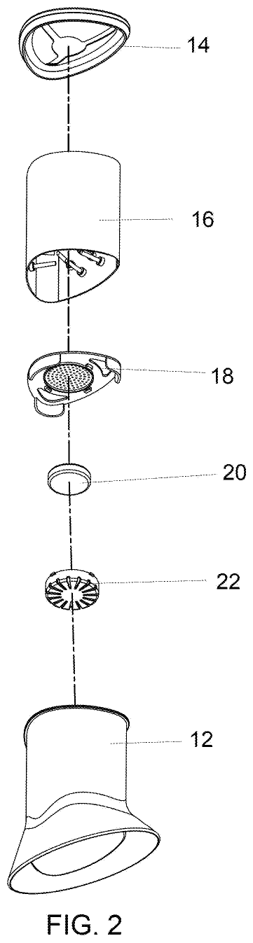

FIG. 2 is an illustration of an exploded view of the device.

The following components are illustrated in FIG. 2.
12—outer casing provides a housing for the components of the device of the embodiment.
14—cover fits on top of the outer casing.
16—inner casing can hold water when water is added to the device.
18—filter collects dirt and grime and the like.
20—soap is provided in solid form and a portion of it dissolves forming a solution in inner casing when water is added.
22—soap holder provides a tray for soap 20.

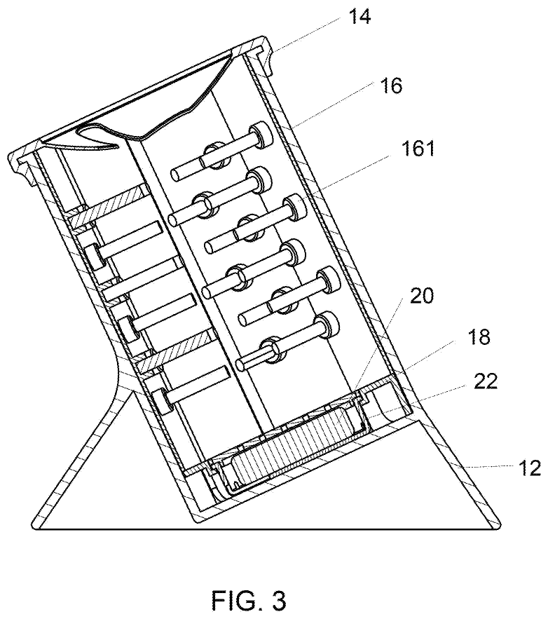

FIG. 3 is an illustration of a cross-sectional view of the device.
161—bristles are illustrated in FIG. 3 and provide a mechanism for cleaning the paw of an animal, e.g., a dog or cat when the paw comes in contact with the bristles.

As in FIG. 2, 12—outer casing provides a housing for the components of the device of the embodiment.

As in FIG. 2, 14—cover fits on top of the outer casing.

As in FIG. 2, 16—inner casing can hold water when water is added to the device.

As in FIG. 2, 18—filter collects dirt and grime and the like.

As in FIG. 2, 20—soap is provided in solid form and a portion of it dissolves forming a solution in inner casing when water is added.

As in FIG. 2, 22—soap holder provides a tray for soap 20.

The illustrations of embodiments described herein are intended to provide a general understanding of the structure of various embodiments, and they are not intended to serve as a complete description of all the elements and features of apparatus and systems that might make use of the structures described herein.

Many other embodiments will be apparent to those of skill in the art upon reviewing the above description. Other embodiments may be utilized and derived therefrom, such that structural and logical substitutions and changes may be made without departing from the scope of this disclosure.

Figures are also merely representational and may not be drawn to scale. Certain proportions thereof may be exaggerated, while others may be minimized. Accordingly, the specification and drawings are to be regarded in an illustrative rather than a restrictive sense.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. An animal paw washing device, comprising:
an inner casing configured to hold water when water is added to the device;
soap or other cleaning composition provided in solid form;
a tray for the soap or other cleaning composition provided in solid form, wherein a portion of the soap or other cleaning composition provided in solid form is dissolvable to form a solution in inner casing when water is added.

2. The animal paw washing device of claim 1, further comprising an outer casing providing a housing for the inner casing.

3. The animal paw washing device of claim 1, further comprising a cover fitting on top of the outer casing.

4. The animal paw washing device of claim 1, further comprising a filter for collecting debris.

5. The animal paw washing device of claim 1, wherein the filter is positioned above the solid soap or other solid cleaning composition.

6. The animal paw washing device of claim 1, wherein the inner casing is cylindrical.

7. The animal paw washing device of claim 1, wherein the tray is circular.

8. The animal paw washing device of claim 1, further comprising a plurality of bristles.

9. The animal paw washing device of claim 1, wherein the plurality of bristles extend inward from the walls of the inner casing.

10. The animal paw washing device of claim 3, wherein the cover has an opening configured to allow for the entry of a paw of an animal.

11. The animal paw washing device of claim 2, wherein the outer casing is cylindrical.
